(19) United States
(12) Patent Application Publication
(10) Pub. No.: US 2026/0348355 A1
(43) Pub. Date: Nov. 5, 2026

(54) WIND TURBINE SYSTEM WITH HEAT-ASSISTED AIRFLOW

(71) Applicant: James DeBoe, Buffalo, ND (US)

(72) Inventor: James DeBoe, Buffalo, ND (US)

(21) Appl. No.: 19/659,504

(22) Filed: Apr. 27, 2026

Related U.S. Application Data
(60) Provisional application No. 63/798,144, filed on May 1, 2025.

(51) Int. Cl. F03D 3/04; F03D 9/25

(52) U.S. Cl. CPC F03D 3/0409; F03D 9/25; F05B 2220/706

(57) ABSTRACT

A wind turbine system includes a ducted wind turbine; a generator system powered by the ducted wind turbine; and a heat generating system to augment airflow through the ducted wind turbine for power generation by the generator system.

### CROSS REFERENCE TO RELATED APPLICATION[S]

The present disclosure claims priority to United States Provisional Patent Disclosure Serial No. 63/798144 filed May 1, 2025.

### BACKGROUND

The present disclosure relates to wind energy generation systems, and more specifically to ducted wind turbines that enhance airflow using waste heat from external sources.

Traditional wind turbines often struggle to generate sufficient power in low wind conditions, limiting their efficiency and applicability in certain environments. Additionally, computing devices, such as those used for cryptocurrency mining, produce significant waste heat during operation, which is typically dissipated through cooling systems, resulting in energy loss.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A wind turbine system according to one disclosed non-limiting embodiment of the present disclosure includes a ducted wind turbine; a generator system powered by the ducted wind turbine; and a heat generating system to augment airflow through the ducted wind turbine for power generation by the generator system.

A further embodiment of any of the foregoing embodiments of the present disclosure in which a chimney transverse to the ducted wind turbine, wherein the heat generating system communicates with the chimney transverse to an axis of the ducted wind turbine.

A further embodiment of any of the foregoing embodiments of the present disclosure in which the heat generating system communicates with the chimney.

A further embodiment of any of the foregoing embodiments of the present disclosure in which the heat generating system comprises an enclosure.

A further embodiment of any of the foregoing embodiments of the present disclosure in which the heat generating system comprises a data center.

A further embodiment of any of the foregoing embodiments of the present disclosure in which the heat generating system comprises a cryptocurrency mining system.

A further embodiment of any of the foregoing embodiments of the present disclosure in which the ducted wind turbine comprises a throat that contains the turbine, the turbine in communication with the generator system.

A further embodiment of any of the foregoing embodiments of the present disclosure in which the heat generating system communicates with the throat downstream of the turbine.

A further embodiment of any of the foregoing embodiments of the present disclosure in which an intake is downstream of the throat.

A further embodiment of any of the foregoing embodiments of the present disclosure in which the heat generating system communicates with the intake upstream of the turbine.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1A is a schematic view of the wind turbine system with a chimney according to one disclosed non-limiting embodiment.

FIG. 1B is a schematic view of the wind turbine system with a chimney according to another disclosed non-limiting embodiment.

FIG. 1C is a schematic view of the wind turbine system with a chimney according to another disclosed non-limiting embodiment.

FIG. 2A is a schematic view of the wind turbine system according to another disclosed non-limiting embodiment.

FIG. 2B is a schematic view of the wind turbine system according to another disclosed non-limiting embodiment.

### DETAILED DESCRIPTION

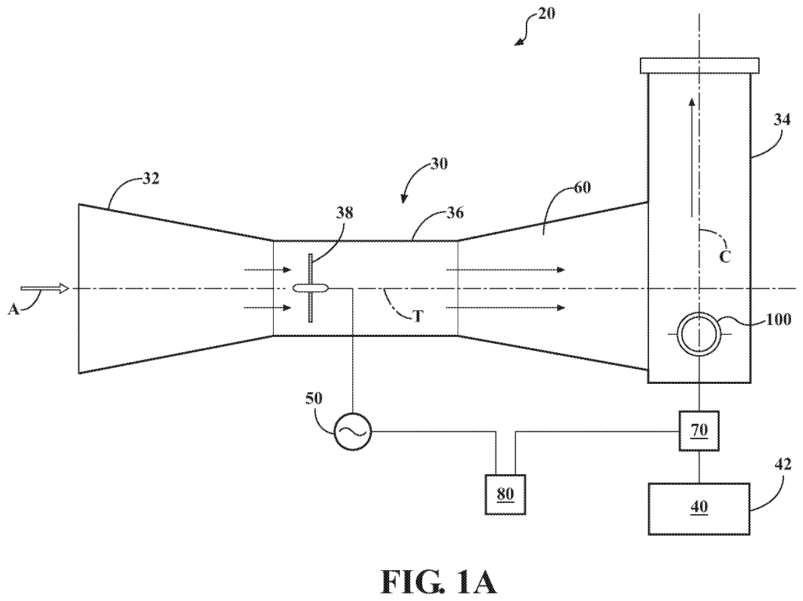

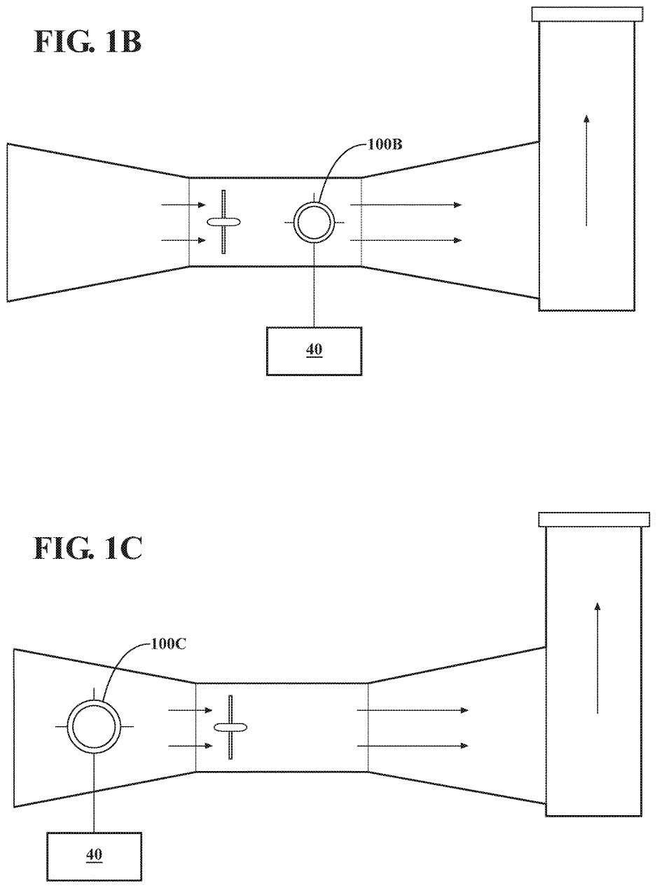

FIG. 1A schematically illustrates a wind turbine system 20 to enhance power generation by utilizing waste heat from computing devices. The wind turbine system 20 includes a ducted wind turbine 30 that generates electrical energy from the wind, with enhanced performance by utilizing waste heat from a heat generating system 40 to augment airflow A through the ducted wind turbine 30 for power generation by a generator system 50. The heat generating system 40 may include cryptocurrency miners or other computing devices to include but not be limited to servers housed in an enclosure 42, which may be a data center, shipping container, or similar structure.

In one embodiment, the ducted wind turbine 30 includes an intake 32, a chimney 34, and a throat 36 that contains a turbine 38 between the intake 32 and the chimney 34. The intake 32 forms a diameter larger than the throat 36 to facilitate airflow A therethrough and into the turbine 38. The turbine 38 rotates about an axis T which is parallel to a longitudinal length of the ducted wind turbine 30 and transverse to the chimney 34 along an axis C.

The ducted wind turbine 30 may include an expansion section 60 downstream of the throat 36 and upstream of the chimney 34. The ducted wind turbine 30 thereby takes advantage of the Venturi effect in which a reduction in fluid pressure occurs when a fluid flows through the constricted throat 36 of the ducted wind turbine 30 within which the turbine 38 is located.

Downstream of the turbine 38, the airflow expands into the chimney 34 through which heated air AH, which was heated by the heat generating system 40 within the enclosure 42, is communicated transverse to the airflow A. The chimney 34 is downstream of the expansion section 60 and transverse thereto.

The heated air AH rises through the chimney 34, forming a buoyancy-driven draft that pulls the airflow A through the wind turbine system 20 to increase airflow over the turbine 38 boosting power output, particularly in low wind conditions to the generator system 50. Various valves and flow control mechanisms such as a blower (illustrated schematically at 70) may be provided at an injection port 100 from the heat generating system 40 to create a vacuum effect and pull the heated air to the injection port 100. Injecting heat at the chimney 34 creates a stack effect that reduces static pressure at the diffuser exit, lowering back-pressure on the rotor. This improves overall system pressure recovery by reducing exit flow resistance. It strengthens the overall draft through the entire system. It helps manage exit flow and reduces recirculation. It warms the exit surfaces to prevent ice formation in cold climate. A control system 80 may be in communication with the generator 50 and the flow control mechanism 70 to facilitate operation of the wind turbine system 20. The control system 80 may include at least one processor, e.g., microprocessor, microcontroller, digital signal processor, etc., a memory, and an input/output (I/O) interface. The processor and the I/O interface are communicatively coupled to the memory. The memory may be embodied as various forms of ROM, RAM, which stores data and control algorithms such as the logic described herein to control, for example the flow control mechanism 70, the pitch of the turbine, etc. The I/O interface is communicatively coupled to a number of hardware, firmware, and/or software components.

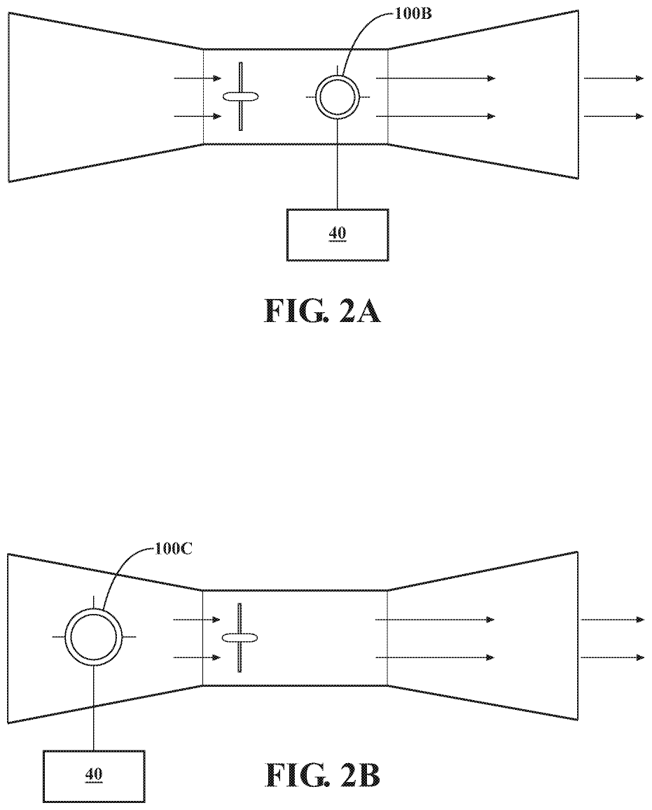

With reference to FIG. 1B, alternatively, in another embodiment, the injection port 100B from the heat generating system 40 may be located in the throat 36 downstream of the turbine 38 with a chimney 34 (FIG. 1B) or without (FIG. 2A). Injecting heat at the throat 36 delivers the buoyancy boost directly at the rotor plane. This maximizes the immediate increase in local velocity and dynamic pressure through the rotor. This minimizes thermal losses between the heat source and the rotor plane, preserving more of the temperature differential. This provides rapid response to fluctuating wind speeds. This warms the rotor area to prevent ice accretion on blades and hub in cold climates.

With reference to FIG. 1C, alternatively, in another embodiment, the injection port 100C from the heat generating system 40 may be located in the intake 32 upstream of the throat 36 with a chimney 34 (FIG. 1C) or without (FIG. 2B) Injecting heat upstream of the throat 36 reduces air density across the full capture area at the earliest point in the flow path. This creates the largest buoyancy pressure gradient from the start of the duct. This allows the buoyancy effect to function in near-calm ambient conditions. This raises inlet air temperature to prevent ice formation on leading surfaces in cold climates.

The wind turbine system 20 provides an efficient and sustainable solution for wind energy generation by repurposing waste heat which addresses limitations of traditional wind turbines.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A wind turbine system, comprising:
a ducted wind turbine;
a generator system powered by the ducted wind turbine; and
a heat generating system to augment airflow through the ducted wind turbine for power generation by the generator system.

2. The wind turbine system as recited in claim 1, further comprising a chimney transverse to the ducted wind turbine, wherein the heat generating system communicates with the chimney transverse to an axis of the ducted wind turbine.

3. The wind turbine system as recited in claim 2, wherein the heat generating system communicates with the chimney.

4. The wind turbine system as recited in claim 1, wherein the heat generating system comprises an enclosure.

5. The wind turbine system as recited in claim 4, wherein the heat generating system comprises a data center.

6. The wind turbine system as recited in claim 4, wherein the heat generating system comprises a cryptocurrency mining system.

7. The wind turbine system as recited in claim 1, wherein the ducted wind turbine comprises a throat that contains a turbine, the turbine in communication with the generator system.

8. The wind turbine system as recited in claim 7, wherein the heat generating system communicates with the throat downstream of the turbine.

9. The wind turbine system as recited in claim 7, further comprising an intake downstream of the throat.

10. The wind turbine system as recited in claim 8, wherein the heat generating system communicates with the intake upstream of the turbine.
